(19) United States
(12) Patent Application Publication
(10) Pub. No.: US 2013/0208712 A1
(43) Pub. Date: Aug. 15, 2013

(54) DISASTER PREVENTION SYSTEM BASED ON WIRELESS LOCAL AREA NETWORK AND METHOD FOR THE SAME

(71) Applicants: Je Hun LEE, Daejeon (KR); Sok Kyu Lee, Daejeon (KR); Hyun Kyu Chung, Daejeon (KR)

(72) Inventors: Je Hun LEE, Daejeon (KR); Sok Kyu Lee, Daejeon (KR); Hyun Kyu Chung, Daejeon (KR)

(73) Assignee: Electronics and Telecommunications Research Institute, Daejeon (KR)

(21) Appl. No.: 13/615,382

(22) Filed: Sep. 13, 2012

(30) Foreign Application Priority Data
Feb. 9, 2012 (KR) 10-2012-0013293

(51) Int. Cl. H04W 4/22

(52) U.S. Cl. 370/338

(57) ABSTRACT

A method of operating a disaster prevention system by a disaster prevention center is provided. The method includes: receiving a disaster situation generation report message including disaster information from a user equipment via an access point (AP); generating disaster response information based on the disaster information; and transmitting a disaster broadcasting message including the disaster response information to the disaster prevention center through the AP.

### CROSS-REFERENCE TO RELATED APPLICATIONS

This application claims the benefit of priority of Korean Patent Application No. 10-2012-0013293 filed on Feb. 9, 2012, which is incorporated by reference in their entirety herein.

### BACKGROUND OF THE INVENTION

1. Field of the invention

The present invention relates to a disaster prevention system, and more particularly, to a disaster prevention system based on a wireless local area network (WLAN) and an apparatus of supporting the same.

2. Related Art

Various disasters such as a typhoon, a tidal wave, a heavy rain, a tremendous snow, an earthquake, a forest fire, a collapse of a road, a gas accident, and the like, occur in an unexpected situation to cause many personal and material damages. Each public or private organization established in order to cope with this disaster situation collects information on the disaster situation and establishes appropriate countermeasures for each disaster situation.

How fast the information on a disaster is acquired at the time of generation of the disaster is closely related to miniaturization of a damage against the disaster. In addition, how accurately the information on a disaster is acquired also has an effect on establishment of countermeasures for reducing a damage.

In connection with the acquisition of the information on the disaster situation, whether the disaster situation may be rapidly informed and propagated to the surrounding is also significantly related to the miniaturization of the damage.

Meanwhile, in accordance with the development of various communication technologies, the tendency to apply corresponding technologies to a disaster prevention system has been accelerated. Particularly, due to the spread of a smart phone, each of the users has used various wireless communications such as mobile communication, a wireless local area network (WLAN), and wireless broadband communication (WiBro). Therefore, a disaster prevention system capable of acquiring information related to a situation and propagating and informing a disaster situation based on the communication technology as described above from the users has been suggested.

### SUMMARY OF THE INVENTION

The present invention provides a disaster prevention system based on a wireless local area network (WLAN) and a method of supporting the same.

In an aspect, a method of operating a disaster prevention system by a disaster prevention center is provided. The method includes: receiving a disaster situation generation report message including disaster information from a user equipment via an access point (AP); generating disaster response information based on the disaster information; and transmitting a disaster broadcasting message including the disaster response information to the disaster prevention center through the AP.

The disaster situation generation report message may be transferred to from the user equipment to the AP based on a wireless local area network (WLAN).

The disaster broadcasting message may be transferred from the AP to the user equipment based on the WLAN.

The disaster broadcasting message may be broadcasted to be transferred to the user equipment.

The disaster broadcasting message may be a beacon frame.

The disaster information may includes: identification information of the user equipment; position information of the user equipment; and category and level information of the disaster.

The disaster response information may include: information on the category and level information of the disaster; position information of the disaster; disaster evacuation information; and period information of the disaster broadcasting message.

The position information of the disaster may be position information of the user equipment. The disaster evacuation information may include shelter position information and shelter phone number list information.

The method may further include allocating an authentication key for participating in a disaster prevention operation to the user equipment.

The allocating of the authentication key may include: receiving a disaster prevention operation participation request message including the identification information of the user equipment from the user equipment; and transferring a disaster prevention operation participation response message including the authentication key to the user equipment.

The identification information of the user equipment may be a medium access control (MAC) address.

The authentication key may be the sum of the MAC address and an equipment serial number imparted to the user equipment by the disaster prevention center.

The authentication key may be determined based on the MAC address and personal information of an owner of the user equipment.

In another aspect, a disaster prevention system is provided. The system includes: a disaster prevention center coping with disaster information reported in connection with a disaster situation sensed by a user equipment; and a network exchanging a message between the user equipment and the disaster prevention center. The disaster prevention center includes: a disaster report processor processing the disaster information; and a disaster information manager generating disaster response information based on the processed disaster information and transmitting disaster broadcasting information including the disaster response information to the user equipment.

The network may include: an access point (AP) receiving a disaster situation generation report message from the user equipment to transfer the disaster situation generation report message to a core network and transmitting a disaster broadcasting message from the core network to transmit the disaster broadcasting message to the user equipment; and the core network transmitting the disaster situation generation report message transferred from the user equipment to the disaster prevention center and receiving the disaster broadcasting message from the disaster prevention center to transfer the disaster broadcasting message to the AP. The disaster situation generation report message may include the disaster information, and the disaster broadcasting message may include the disaster broadcasting information.

The disaster situation generation report message and the disaster broadcasting message may be transmitted based on a WLAN.

The disaster broadcasting message transmitted to the user equipment by the AP may be broadcasted and transmitted.

The disaster broadcasting message may be a beacon frame periodically broadcasted by the AP including the disaster response information.

In still another aspect, a user equipment supporting disaster prevention is provided. The user equipment includes: a disaster report processor sensing a disaster situation to generate disaster information and transmitting a disaster situation generation report message including the disaster information to a disaster prevention center; and a disaster information processor receiving a disaster broadcasting message transmitted from the disaster prevention center corresponding to the disaster situation generation report message and processing and informing disaster response information included in the disaster broadcasting message. The transmission of the disaster situation generation report message to the disaster prevention center and the reception of the disaster broadcasting message from the disaster prevention center may be performed by a WLAN.

The user equipment may further include a disaster application manager managing an authentication key allocated from the disaster prevention center in order to participate in a disaster prevention operation. The user equipment may include a disaster prevention application downloaded from an application server for the disaster prevention operation.

### BRIEF DESCRIPTION OF THE DRAWINGS

FIG. 1 is a diagram showing a constitution of a disaster prevention system according to an exemplary embodiment of the present invention.

FIG. 2 is a diagram showing a detailed structure of the disaster prevention system according to the exemplary embodiment of the present invention.

FIG. 3 is a flow chart showing a disaster prevention operation method of operating the disaster prevention system according to the exemplary embodiment of the present invention.

FIG. 4 is a block diagram showing a format of a disaster situation generation report frame according to the exemplary embodiment of the present invention.

FIG. 5 shows an example of an operation related to installation of a disaster prevention application of a user equipment and allocation of an authentication key in the disaster prevention system according to the exemplary embodiment of the present invention.

FIG. 6 is a diagram an example related to report of a disaster situation of the user equipment and disaster broadcasting of a disaster prevention center in the disaster prevention system according to the exemplary embodiment of the present invention.

FIG. 7 is a diagram showing an example of a method of informing disaster response information transmitted to a user by the user equipment according to the exemplary embodiment of the present invention.

### DESCRIPTION OF EXEMPLARY EMBODIMENTS

Hereinafter, exemplary embodiments of the present invention will be described in detail with reference to the accompanying drawings so that those skilled in the art may easily practice the present invention. However, the present invention may be modified in various different ways and is not limited to the exemplary embodiments provided in the present description. In the accompanying drawings, portions unrelated to the description will be omitted in order to obviously describe the present invention, and similar reference numerals will be used to describe similar portions throughout the present specification.

Throughout the present specification, unless explicitly described to the contrary, “comprising” any components will be understood to imply the inclusion of other elements rather than the exclusion of any other elements. A term “part”, “module”, “unit”, or the like, described in the specification means a unit of processing at least one function or operation and may be implemented by hardware or software or a combination of hardware and software.

Due to the spread of apparatuses supporting a plurality of wireless communication scheme, such as a smart phone, organizations have installed a wide communication infrastructure in order to provide a better service. Since the smart phone supports various wireless communication systems such as mobile communication, a wireless local area network (WLAN), wireless broadband communication (WiBro), infrastructures such as a base station for a WiBro service and an access point (AP) for a WLAN service have been widely installed.

In addition, various services have been developed and provided through the spread of various applications in order to utilize the smart phone supporting the wireless communication as described above.

However, a wide disaster prevention system based on the application of the smart phone and the WLAN service are not currently suggested and utilized. The disaster prevention system based on the application and the WLAN may be more efficient in that it may be provided through update of software in a user side and a service provider side without separate upgrade of hardware.

Therefore, in a situation in which enterprise or public WLAN infrastructures are expanded in a large scale together with a tremendous increase in a user equipment in which a WLAN function is mounted, such as the smart phone, a disaster prevention system capable of utilizing these infrastructures through update of software without upgrade of hardware in a user side and a service provider side is suggested.

Hereinafter, a disaster prevention system based on a WLAN according to an exemplary embodiment of the present invention will be described by way of example. However, the scope of the present invention is not limited only to the disaster prevention system based on a WLAN, but may also be applied to a disaster prevention system based on a wireless communication system capable of transmitting and/or receiving related information based on a real time request/response.

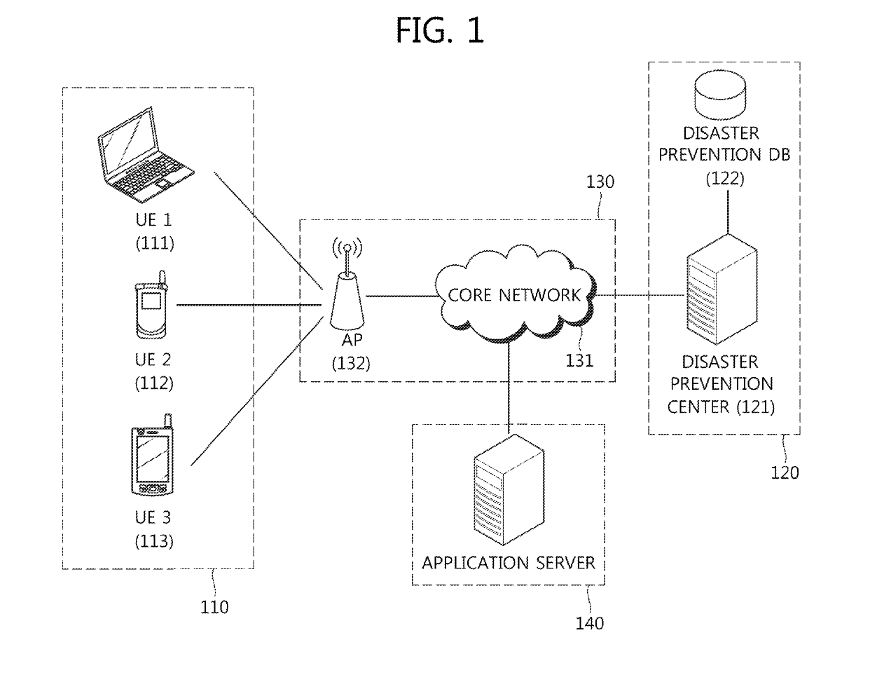

FIG. 1 is a diagram showing a constitution of a disaster prevention system according to an exemplary embodiment of the present invention.

Referring to FIG. 1, the disaster prevention system 100 according to the exemplary embodiment of the present invention includes a user equipment side 110, a disaster prevention center side 120, and an application support side 130.

The user equipment side 110 includes at least one user equipments 111, 112, and 113 including a disaster prevention application.

The disaster prevention center side 120 includes a disaster prevention center 121 and a disaster prevention database (DB) unit 122. The disaster prevention center side 120 monitors a disaster situation in real time.

The application support side 140 includes an application server (App server). The app server provides a disaster prevention application so that a user equipment that does not support disaster prevention may support the disaster prevention.

The user equipment side 110, the disaster prevention center side 120, and the application support side 140 are connected to each other through a network side 130 to exchange related information with each other. The network side 130 includes a core network 131 supporting the Internet service and an access point (AP) 132 supporting a WLAN service of the equipment.

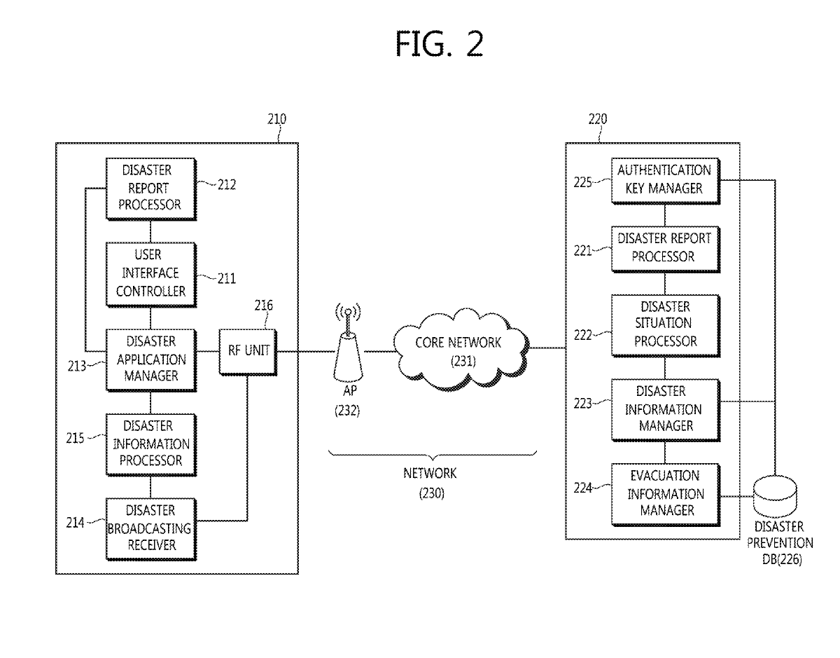

FIG. 2 is a diagram showing a detailed structure of the disaster prevention system according to the exemplary embodiment of the present invention.

Referring to FIG. 2, a user equipment 210 of the user equipment side includes a user interface controller 211, a disaster report processor 212, a disaster application (app) manager 213, a disaster information broadcasting receiver 214, a disaster information processor 215, and a radio frequency (RF) unit 216.

The user interface controller 211 performs a function required for interworking with a user input/output interface of the user equipment.

The disaster report processor 212 supports a function for a report of a disaster situation in the case in which a user using the user equipment directly reports the disaster situation. The disaster report processor 212 may request that the reported disaster report is cancelled if needed.

The disaster app manager 213 may download and install the disaster prevention application through the app server or update an application installed in the user equipment. The disaster app manager 213 manages an authentication key for interworking with the disaster prevention system.

The disaster broadcasting receiver 214 receives information related to disaster broadcasting received through the AP 232 to transmit the received information to the disaster information processor.

The disaster information processor 215 processes the information related to disaster broadcasting transferred from the disaster broadcasting receiver 214 to provide the processed information as a service to the user.

The RF unit 216 performs a function for transmission and reception of a wireless signal of the user equipment, and particularly, supports transmission and reception of a wireless signal based on the WLAN.

A disaster prevention center 220 of the disaster prevention center side includes a disaster report processor 221, a disaster situation processor 222, a disaster information manager 223, an evacuation information manager 224, and an authentication key manager 225.

The disaster report processor 221 processes the disaster information reported from the user equipment 210 and transmits the primarily processed disaster information to the disaster situation processor.

The disaster situation processor 222 determines a countermeasure against the disaster situation based on the processed disaster information.

The disaster information manager 223 processes the processed disaster information and disaster response information related to corresponding countermeasures against the disaster situation to store the processed information in a disaster prevention DB 226.

The evacuation information manager 224 transmits related information to the user equipment through the disaster information manager if needed, while managing disaster response information according to an area/situation identified for each disaster situation. The disaster response information may include disaster information and disaster evacuation information.

The authentication key manager 225 manages an authentication key for identifying the user equipment to which a disaster situation report is allowed. In order to cope with an erroneous disaster situation report through any user equipment, the authentication key is applied to the user equipment to which the disaster situation report is allowed, and the authentication key is retrieved in the case the allowance is cancelled. The authentication key manager 225 performs a general function related to allocation/retrieval of the authentication key to/from each user equipment.

The disaster prevention DB 226 stores the disaster information reported from the user equipment 210 and the disaster information processed in the disaster prevention center. In addition, the disaster prevention DB 226 stores the disaster evacuation information according to an area/situation identified based on the disaster information.

The user equipment 210 and the disaster prevention center side 220 exchange information with each other through the network 230. The network 230 includes a core network 231 and an access point 232. The core network 231 means a general network providing the general Internet service. The access point 232 is connected to the core network 231 to provide a WLAN service to at least one user equipment 210.

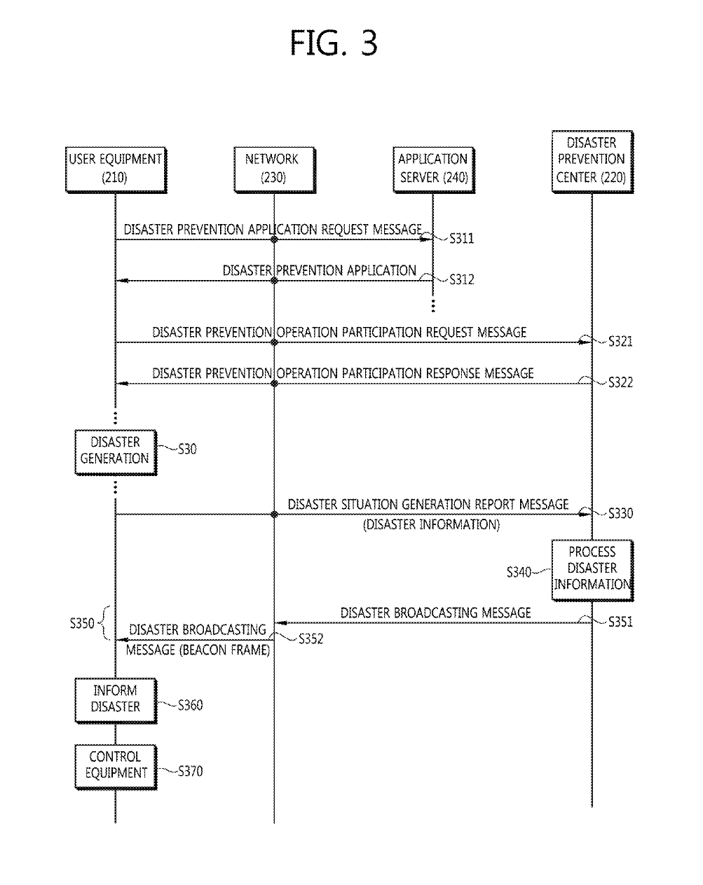

FIG. 3 is a flow chart showing a disaster prevention operation method of operating the disaster prevention system according to the exemplary embodiment of the present invention. It is assumed that the user equipment 210 does not include an application for disaster prevention.

Referring to FIG. 3, a user equipment 210 transmits a disaster prevention application request message to an application server 240 in order to include a disaster prevention application (S311). The application server 240 transmits the disaster prevention application to the user equipment 210 for installation of the disaster prevention application in response to the request of the user equipment 210 (S312). When the user equipment 210 receives the disaster prevention application, the user equipment 210 may install and use the disaster prevention application.

As a specific process of requesting, downloading, and installing a disaster prevention application in the user equipment, an equipment operation system that is being applied to the user equipment or an existing method that is being serviced by a communication company is used as it is. That is, the application server may be an application store provided by a specific communication company, and the user equipment may download a disaster prevention application from a corresponding application store and install and use the disaster prevention application. Alternatively, a disaster prevention application basically provided to an operation system of a user equipment may be used.

The user equipment 210 needs to join in a disaster prevention center 220 in order to participate in a disaster prevention operation based on a disaster prevention system. To this end, the user equipment 210 may be allocated with an authentication key for participating in the disaster prevention operation during an initial process for the disaster prevention operation. The user equipment 210 transmits a disaster prevention operation participation request message including identification information of the user equipment 210 to the disaster prevention center 220 in order to be allocated with the authentication key (S321).

When the disaster prevention center 220 receives the disaster prevention operation participation request message from the user equipment 210, the disaster prevention center 220 determines whether or not disaster prevention operation participation is allowed based on the identification information of the corresponding user equipment 210. The disaster prevention center 220 transmits a disaster prevention operation participation operation message to the user equipment 210 in response to the request message (S222). The disaster prevention operation participation response message may include information indicating whether or not participation in a disaster prevention operation of the user equipment 210 is allowed and the authentication key in the case in which the participation in the disaster prevention operation is allowed.

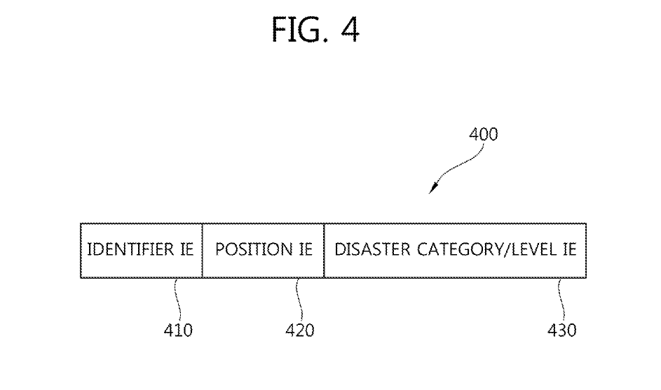

When a disaster 210 is generated (S30), the user equipment 210 transmits a disaster situation generation report message including disaster information to the disaster prevention center 220 (S330). The disaster situation generation report message may be implemented as an action frame used in the WLAN system. This may be called a disaster situation generation report frame. Hereinafter, a description will be provided with reference to FIG. 4.

FIG. 4 is a block diagram showing a format of a disaster situation generation report frame according to the exemplary embodiment of the present invention.

Referring to FIG. 4, a disaster situation generation report frame 400 includes an identifier information element (IE) 410, a position IE 420, and a disaster category/level IE 430 as disaster information. The disaster information of the disaster situation generation report message may be configured of a combination of the above-mentioned information elements.

The identifier information element 410 may include identifier information of a transmit user equipment transmitting the disaster information of the disaster situation generation report frame 400. As the identifier information, an MAC address of the user equipment and/or authorization key information allocated for a disaster situation prevention operation may be included.

The equipment position IE 420 includes information related to a current position of the user equipment 210. The position related information may be implemented as global positioning system (GPS) based position information and/or WiFi positioning system (WPS) information.

A disaster category/level IE 430, which is information related to a disaster situation sensed by the user equipment, indicates a category to which the disaster situation pertains and a level indicating seriousness of the disaster situation.

When the action frame as described above arrives at the AP, the AP transfers the information elements included in the action frame using a security protocol capable of being utilized on the Internet.

Again referring to FIG. 3, the disaster prevention center 220 processes the disaster information based on the information elements included in the disaster situation generation report message (S340). The disaster prevention center 220 processes the disaster information to generate disaster response information. A processing procedure performed in the components of the disaster prevention center 220 described with reference to FIG. 2 may be referred to with respect to a process of processing disaster information in the disaster prevention center 220.

The disaster prevention center 220 transmits a disaster broadcasting message including the disaster response information (S350). The disaster broadcasting message is transmitted through a network 230. The network 230 includes an AP capable of transmitting the disaster broadcasting message transferred from the disaster prevention center 220 as a wireless signal of the WLAN system. That is, the disaster broadcasting message is transferred to all of the APs present in a region in which the disaster situation is generated and is transmitted through the APs. A process in which the AP transmits the disaster broadcasting message may be implemented by allowing the disaster response information to be included in a beacon frame periodically transmitted by the AP and then transmitting the beacon frame.

The disaster broadcasting message transmitted through the beacon frame includes the disaster response information. Therefore, the beacon frame may include a disaster category/level IE, a disaster position IE as the disaster information and a disaster evacuation IE as the disaster response information. The disaster category/level IE indicates a category and seriousness of a disaster situation sensed by the user equipment 210. The disaster position IE includes information related to a position at which the disaster situation sensed by the user equipment 210 is generated.

The disaster evacuation IE, which is disaster evacuation information that needs to be provided to the user equipment 220, corresponding to a corresponding disaster situation, may include shelter position indicating information and shelter phone number list indicating information.

The beacon frame may further include an information element related to disaster broadcasting period information. The disaster broadcasting period information includes information indicating a point in time in which corresponding disaster broadcasting is first generated and a valid period from a corresponding point in time. Therefore, when the user equipment receives disaster broadcasting of which the valid period elapses, the user equipment may ignore or discard the disaster broadcasting of which the valid period elapses. In addition, the valid period may be corrected/updated according to a disaster situation.

The user equipment 210 processes the received disaster broadcasting message to inform a user of a disaster through a user interface (S360).

The user equipment 210 may perform an equipment control based on the disaster response information included in the disaster broadcasting message (S370). In the case in which a disaster situation category indicated by the disaster information corresponds to a specific category and/or a disaster situation level is a specific level or more, the user equipment 210 may perform a power save mode based equipment control minimizing power of a corresponding equipment. As an example, in the case in which a corresponding category is a disaster expected that a problem will occur in view of the supply of power in a wide region including a region in which the user equipment 210 is positioned, the equipment may be operated to minimize the power.

The power save mode based equipment control of the user equipment as described above may be performed according to a mechanism for delivery traffic indication map (DTIM) interval adjustment, general power save mode operation, unscheduled automatic power save delivery (U-APSD) power save mode operation, and/or power save of an equipment itself used in the WLAN system.

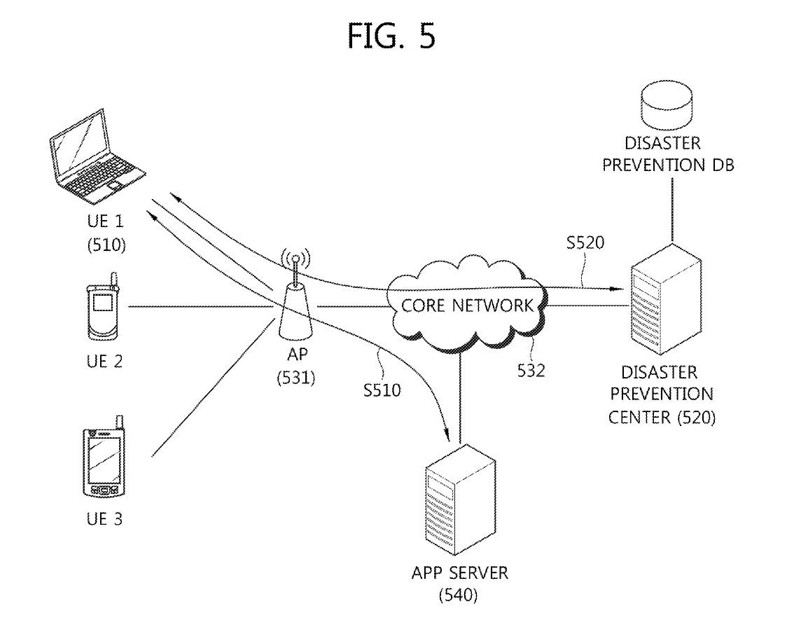

FIG. 5 shows an example of an operation related to installation of a disaster prevention application of a user equipment and allocation of an authentication key in the disaster prevention system according to the exemplary embodiment of the present invention.

Referring to FIG. 5, a user equipment (UE) 1 510 downloads an application from an app server 540 through an access point 531 and a core network 532 and installs the application (S510). An operation related to the download/installation of the application may be in accordance with a procedure related to installation of a general application in the user equipment 510.

The UE 1 510 completing the installation of the disaster prevention application requests a disaster prevention center 520 for participation in a disaster prevention operation, thereby being allocated with an authentication key (S520).

In connection with the disaster prevention application, the UE 1 510 may store unique identifier information of an equipment, the authentication key allocated from the disaster prevention center, and position information of the UE 1 510.

The unique identifier information of the UE 1 510 may be a phone number or an MAC address of a WLAN supporting chip set used in the UE 1 510.

The authentication key allocated from the disaster prevention center is used at the time of reporting a disaster situation, and a type of authentication key may be set in various schemes by the request of the disaster prevention center and/or the equipment. As an example, the authentication key may be set to a value obtained by adding an MAC address of the UE 1 510 and a serial number of the equipment imparted to the UE 1 510 by the disaster prevention center to each other. Alternatively, the authentication key may be set to a value obtained by adding the MAC address of the UE 1 510 and personal information such as a resident registration number of an equipment owner to each other.

The position information of the UE 1 510 may be GPS information in the case in which the user equipment is positioned outside. In addition, the position information of the UE 1 510 may be position information that may be acquired from the AP to which the user equipment is connected in the case in which the user equipment is positioned inside, and may be position information based on a WPS and/or recently recognized position information in the case in which the user equipment supports the WPS.

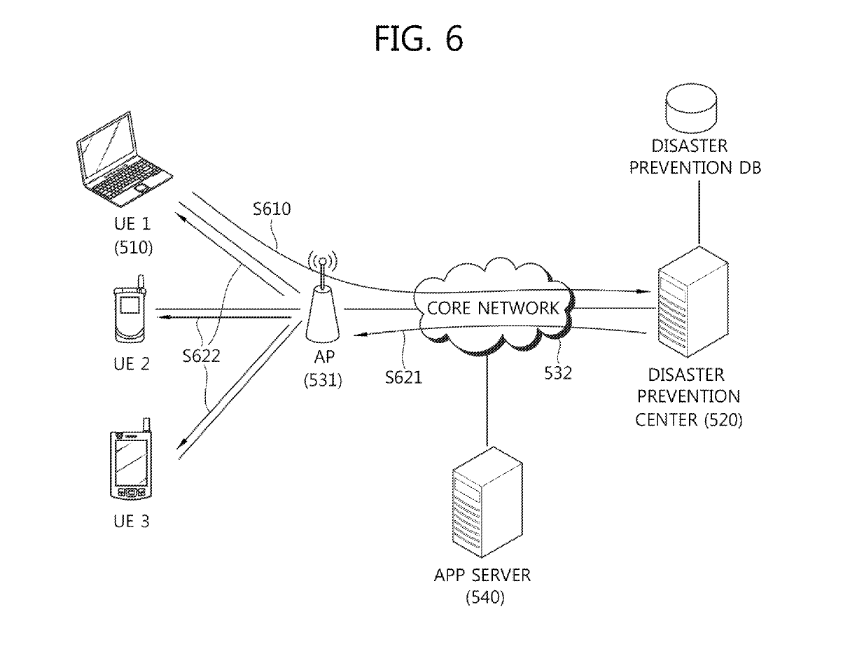

FIG. 6 is a diagram an example related to report of a disaster situation of the user equipment and disaster broadcasting of a disaster prevention center in the disaster prevention system according to the exemplary embodiment of the present invention.

Referring to FIG. 6, a UE 1 510 sensing disaster generation transmits a disaster situation generation report message having an action frame format to a disaster preventions center 520 via an AP 531 (S610). The disaster situation generation report message may include an identifier IE, a position IE of the user equipment, and/or a disaster category/level IE of the UE 1 510. The transmission of the disaster situation generation report message to the disaster preventions center 520 may be that a frame format appropriate for a WLAN protocol of the user equipment is transmitted to an AP 531 and the AP 531 transfers the frame format to the disaster prevention center 532 through a core network 532.

When the disaster prevention center 520 receives the disaster situation generation report message, it authenticates/processes a corresponding report message to inform UEs of information matched to a corresponding disaster situation. A process in which the disaster prevention center 520 informs the UEs of the corresponding information may be implemented by transmitting a disaster broadcasting message to the AP 531 (S621) and allowing information included in the disaster broadcasting message to be included in a beacon frame and then transmitting the beacon frame by the AP 531 (S622).

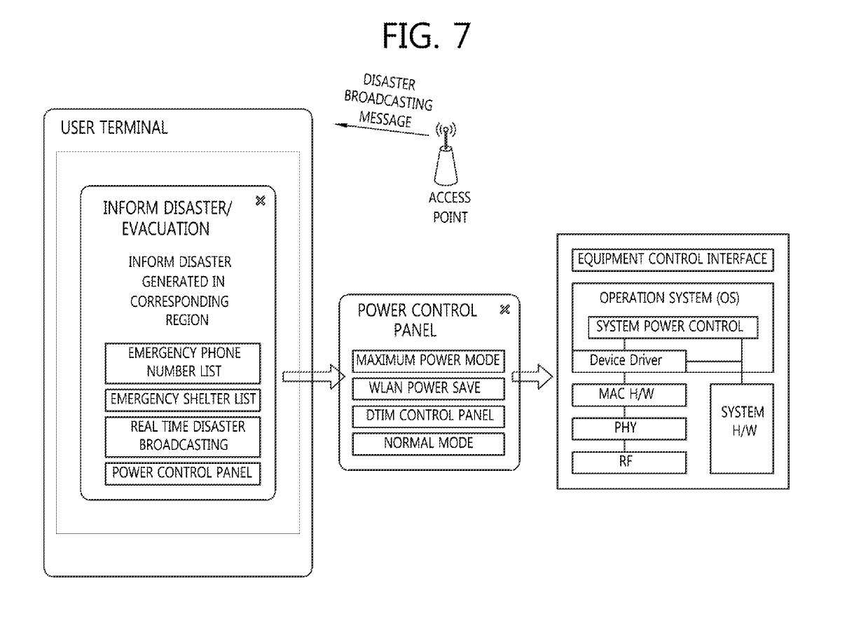

FIG. 7 is a diagram showing an example of a method of informing disaster response information transmitted to a user by the user equipment according to the exemplary embodiment of the present invention.

Referring to FIG. 7, when the user equipment receives the disaster broadcasting message, a user interface controller of the user equipment informs a user of a disaster using a graphical user interface (GUI). The GUI may be implemented by executing a disaster prevention application. The disaster prevention application displays a specific content of disaster response information.

A category such as an emergency phone number list, an emergency shelter list, and real time disaster broadcasting is formed by concretizing each information included in the disaster response information for an interface.

Here, in addition to the disaster related information, a function capable of controlling power may also be additionally implemented. A function related to the power control of the user equipment may be displayed as a power control panel menu by a user interface unit of the user equipment.

As in an example of FIG. 7, a mode capable of maximally saving the power may be present in the power control panel. This mode, which is a power save function in view of a user equipment system, is a mode of switching power of the entire system into a maximum power save mode, including a separately provided WLAN power save mode, that is, a power save method based on a power save mode method suggested on a WLAN protocol. In addition, a method of increasing a DTIM interval through a DTIM adjusting panel to expect additional power save at the time of a WLAN power save mode may be suggested. In this case, a disaster prevention application of a user equipment may interwork with a system power control block of the user equipment through a user interface to perform various types of power save functions including a WLAN power save mode. When a power save mode operation of the user equipment is adjusted through an equipment control interface, the power save mode operation of hardware configuring the user equipment is performed through an operation system of the user equipment.

As set forth above, according to the exemplary embodiments of the present invention, an equipment such as a smart phone supporting wireless communication based on various communication protocols is spread, thereby making it possible to easily configure and operate a disaster prevention network only through installation of a simple application or upgrade of software using a widely spread WLAN. Particularly, since an operation method is additionally provided with respect to a power save mode which is the largest disadvantage related to the WLAN in a mobile communication environment, a method capable of more efficiently and bi-directionally (disaster report/disaster broadcasting) coping with a disaster may be provided.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A method of operating a disaster prevention system by a disaster prevention center, the method comprising:
receiving a disaster situation generation report message including disaster information from a user equipment via an access point (AP);
generating disaster response information based on the disaster information; and
transmitting a disaster broadcasting message including the disaster response information to the disaster prevention center through the AP.

2. The method of claim 1, wherein the disaster situation generation report message is transferred to from the user equipment to the AP based on a wireless local area network (WLAN).

3. The method of claim 2, wherein the disaster broadcasting message is transferred from the AP to the user equipment based on the WLAN.

4. The method of claim 3, wherein the disaster broadcasting message is broadcasted to be transferred to the user equipment.

5. The method of claim 4, wherein the disaster broadcasting message is a beacon frame.

6. The method of claim 5, wherein the disaster information includes:
identification information of the user equipment;
position information of the user equipment; and
category and level information of the disaster.

7. The method of claim 6, wherein the disaster response information includes:
information on the category and level information of the disaster;
position information of the disaster;
disaster evacuation information; and
period information of the disaster broadcasting message.

8. The method of claim 7, wherein the position information of the disaster is position information of the user equipment, and
the disaster evacuation information includes shelter position information and shelter phone number list information.

9. The method of claim 5, further comprising allocating an authentication key for participating in a disaster prevention operation to the user equipment.

10. The method of claim 9, wherein the allocating of the authentication key includes:
receiving a disaster prevention operation participation request message including the identification information of the user equipment from the user equipment; and
transferring a disaster prevention operation participation response message including the authentication key to the user equipment.

11. The method of claim 10, wherein the identification information of the user equipment is a medium access control (MAC) address.

12. The method of claim 11, wherein the authentication key is the sum of the MAC address and an equipment serial number imparted to the user equipment by the disaster prevention center.

13. The method of claim 11, wherein the authentication key is determined based on the MAC address and personal information of an owner of the user equipment.

14. A disaster prevention system comprising:
a disaster prevention center coping with disaster information reported in connection with a disaster situation sensed by a user equipment; and
a network exchanging a message between the user equipment and the disaster prevention center,
wherein the disaster prevention center includes:
a disaster report processor processing the disaster information; and
a disaster information manager generating disaster response information based on the processed disaster information and transmitting disaster broadcasting information including the disaster response information to the user equipment.

15. The disaster prevention system of claim 14, wherein the network includes:
an access point (AP) receiving a disaster situation generation report message from the user equipment to transfer the disaster situation generation report message to a core network and transmitting a disaster broadcasting message from the core network to transmit the disaster broadcasting message to the user equipment; and
the core network transmitting the disaster situation generation report message transferred from the user equipment to the disaster prevention center and receiving the disaster broadcasting message from the disaster prevention center to transfer the disaster broadcasting message to the AP,
the disaster situation generation report message including the disaster information, and the disaster broadcasting message including the disaster broadcasting information.

16. The disaster prevention system of claim 15, wherein the disaster situation generation report message and the disaster broadcasting message are transmitted based on a WLAN.

17. The disaster prevention system of claim 16, wherein the disaster broadcasting message transmitted to the user equipment by the AP is broadcasted and transmitted.

18. The disaster prevention system of claim 17, wherein the disaster broadcasting message is a beacon frame periodically broadcasted by the AP including the disaster response information.

19. A user equipment supporting disaster prevention, the user equipment comprising:
a disaster report processor sensing a disaster situation to generate disaster information and transmitting a disaster situation generation report message including the disaster information to a disaster prevention center; and
a disaster information processor receiving a disaster broadcasting message transmitted from the disaster prevention center corresponding to the disaster situation generation report message and processing and informing disaster response information included in the disaster broadcasting message,
wherein the transmission of the disaster situation generation report message to the disaster prevention center and the reception of the disaster broadcasting message from the disaster prevention center are performed by a WLAN.

20. The user equipment of claim 19, further comprising a disaster application manager managing an authentication key allocated from the disaster prevention center in order to participate in a disaster prevention operation,
wherein the user equipment includes a disaster prevention application downloaded from an application server for the disaster prevention operation.
